(19) United States
(12) Patent Application Publication
(10) Pub. No.: US 2026/0307695 A1
(43) Pub. Date: Oct. 8, 2026

(54) PERSONAL TRANSPORTATION SYSTEM

(71) Applicant: TPT Technologies, Inc., Chattanooga, TN (US)

(72) Inventors: Roger Holcombe, Santa Barbara, CA (US); Calvin B. Chamberlain, JR., Chattanooga, TN (US); Byron Broussard, Rocky Face, GA (US); Christen C. Courville, Midlothian, VA (US); Andrew J. Cary, Tampa, FL (US)

(73) Assignee: TPT Technologies, Inc., Chattanooga, TN (US)

(21) Appl. No.: 19/098,951

(22) Filed: Apr. 2, 2025

Related U.S. Application Data
(60) Provisional application No. 63/549,434, filed on Feb. 2, 2024.

(51) Int. Cl. B61L 27/04; B61B 1/02; B61C 3/00; B61L 27/10

(52) U.S. Cl. CPC B61L 27/04; B61B 1/02; B61C 3/00; B61L 27/10; B61L 2201/00; B61L 2210/02

(57) ABSTRACT

The instant disclosure discloses a method of operating a personal ecosystem transportation system that includes receiving instructions to pick up either passengers or freight at a specific siding or terminal, transporting those passengers or freight to a specified siding or terminal using a self-contained electrically powered vehicle, controlling the vehicle from within the vehicle to eliminate the use of external control mechanisms for moving the vehicle from the main track to a siding, and scheduling and programming the vehicle control system to proceed to a charging siding once the current assignment is completed when the vehicle control system determines that the battery of the vehicle requires recharging.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the present disclosure, and the applicants make no claim to any trademarks referenced.

### BACKGROUND

### 1) Field of the Disclosure

The disclosure generally relates to autonomous rail-based transportation systems, specifically to systems that incorporate self-contained electrically powered vehicles operating on a fixed track system with integrated control and charging systems.

### 2) Description of Related Art

Currently the state of the art includes automobiles, trains, bicycle, and motorcycle systems that utilize paved or unsealed surfaces to travel on. These systems have been adapted to move large amounts of freight and people and do it in a reliable manner, but they require either a driver or a driver attendant to pilot the vehicle and they do not provide clean or minimal environmental impact.

The present disclosure relates to a personal transportation system. In particular, it relates to an autonomous transportation system for people and light freight.

Rail-based transportation systems have been a cornerstone of public and freight transportation for centuries. These systems typically involve vehicles, such as trains or trams, that travel along fixed tracks. The vehicles are often powered by electricity, which can be supplied through overhead lines or third rails. The vehicles are typically controlled by a centralized control system, which can manage the movement of multiple vehicles across the network.

One common feature of rail-based transportation systems is the use of sidings. Sidings are short stretches of track that are used to allow trains to pass each other or to store trains that are not in use. Sidings can also be used for loading and unloading passengers or freight. The movement of vehicles onto and off of sidings is typically controlled by external control mechanisms, such as switches or signals.

Another common feature of rail-based transportation systems is the use of a track guidance system. This system is designed to keep the vehicle on the track and prevent it from derailing. The track guidance system can be a physical part of the track, such as a rail or groove, or it can be a separate system that interacts with the vehicle, such as a magnetic or optical guidance system.

Power sources for rail-based transportation vehicles typically include electric motors, which are often powered by batteries. These batteries can be charged at charging stations, which are typically located at terminals or other designated locations along the track. The scheduling of recharging and maintenance for the vehicles is typically managed by the centralized control system.

Finally, in recent years, there has been a growing interest in the use of autonomous vehicles in transportation systems. These vehicles are capable of operating without human intervention, using onboard control systems and sensors to navigate their environment.

Autonomous vehicles can offer a number of potential benefits, such as increased efficiency and safety, as well as the ability to provide transportation services on demand.

Also, the current systems do not provide a simple way for passengers or freight to move between fixed locations such as at airports and withing a city environment comfortably and safely.

These and other objects, features, and advantages of the present disclosure will become more readily apparent from the attached drawings and the detailed description of the preferred embodiments, which follow.

### SUMMARY

Bearing in mind the problems and deficiencies of the prior art, it is therefore an object of the present disclosure to provide a sustainable, nonstop, autonomous, affordable, personal (PRT) ecosystem.

Still other objects and advantages of the disclosure will in part be obvious and will in part be apparent from the specification.

According to an aspect of the present disclosure, the personal ecosystem transportation system includes a fixed track system with sidings for passenger and freight loading and unloading, a self-contained electrically powered vehicle for passenger or freight transportation, a control system, and a charging system. The vehicle travels on the track system and is equipped with its own electrical power source and control system. The track system is designed to be self-centering to eliminate the use of a track guidance system. The power source for the vehicle is primarily a battery that drives an electric motor, which in turn drives at least one wheel. The system includes two different siding systems to move a vehicle off of the main track.

According to other aspects of the present disclosure, the personal ecosystem transportation system may include one or more of the following features. The vehicle may be capable of carrying one to four passengers. The vehicle may be equipped with a ride hailing application for passengers to request the vehicle. The control system may be located within the vehicle, allowing the vehicle to operate autonomously. The track system may be self-centering, eliminating the use of a track guidance system. The power source for the vehicle may include an auxiliary fuel cell to provide power to charge the battery. The system may include a 90- degree vehicle transport device as one of the two different siding systems to move a vehicle off of the main track. The system may include a switch siding design as one of the two different siding systems to move a vehicle off of the main track. The control system may comprise a central management system that manages all the vehicles Online analytical processing (OLAP) and online transaction processing (OLTP). The vehicle control system may communicate with the personal ecosystem transportation system control system to schedule recharging and maintenance. The vehicle control system may signal to the personal ecosystem transportation system when the battery of the vehicle requires recharging.

According to another aspect of the present disclosure, a method of operating a personal ecosystem transportation system includes receiving instructions to pick up either passengers or freight at a specific siding or terminal, transporting those passengers or freight to a specified siding or terminal using a self-contained electrically powered vehicle, controlling the vehicle from within the vehicle to eliminate the use of external control mechanisms for moving the vehicle from the main track to a siding, and scheduling and programming the vehicle control system to proceed to a charging siding once the current assignment is completed when the vehicle control system determines that the battery of the vehicle requires recharging.

According to other aspects of the present disclosure, the method may include one or more of the following features. The self-contained electrically powered vehicle may include an auxiliary fuel cell to provide power to charge the battery. The method may include the step of using a ride hailing application to communicate with the personal ecosystem transportation system control system. The ride hailing application may provide real-time tracking of the vehicle's location and estimated arrival times. The vehicle may be moved off of the main track using a 90-degree vehicle transport device, wherein the rails that the vehicle is being transported on moves perpendicular from the main rail and into a portal for loading or unloading. The moveable rail may have a secondary filler track that fits into the main track so other vehicles can proceed without being delayed.

According to yet another aspect of the present disclosure, a personal ecosystem transportation system control system includes a central management system configured to manage all the vehicles Online analytical processing (OLAP) and online transaction processing (OLTP), a portal siding control system, a vehicle control system residing in the vehicle and designed to communicate with the personal ecosystem transportation system control system, and a ride hailing application configured to communicate with the personal ecosystem transportation system control system. The control system provides information to the personal ecosystem transportation system control system to schedule recharging and maintenance.

According to other aspects of the present disclosure, the personal ecosystem transportation system control system may include one or more of the following features. The vehicle control system may include a motor controller, a battery management system, a user interface, and a communication system to allow the vehicle control system to communicate with the personal ecosystem transportation system control system. The vehicle control system may signal to the personal ecosystem transportation system when the battery requires recharging, and the personal ecosystem transportation system may schedule and program the vehicle control system to proceed to a charging siding once the current assignment is completed.

The above and other objects, which will be apparent to those skilled in the art, are achieved in the present disclosure which is directed to creating a personal transportation system that utilizes fix track to move people and freight from point to point efficiently and safely.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a typical personal ecosystem transportation system, in accordance with one or more embodiments of the present disclosure;

FIG. 2 is a typical view of the track system, in accordance with one or more embodiments of the present disclosure;

FIG. 3 is a typical view of the vehicle and track system, in accordance with one or more embodiments of the present disclosure;

FIG. 4 typical view of the vehicle and track system showing the wheels and rails, in accordance with one or more embodiments of the present disclosure;

FIG. 5 typical view of the vehicle loading station for passengers, in accordance with one or more embodiments of the present disclosure;

FIG. 6 typical view of the vehicle siding system for a loading station for passengers or freight, in accordance with one or more embodiments of the present disclosure;

FIG. 7 shows the vehicle transfer station with a vehicle proceeding on the main track, in accordance with one or more embodiments of the present disclosure;

FIG. 8 shows the vehicle transfer station with a vehicle moved to the loading and unloading station, in accordance with one or more embodiments of the present disclosure;

FIG. 9 shows the vehicle and siding station with a vehicle moving to the loading and unloading station, in accordance with one or more embodiments of the present disclosure;

FIG. 10 shows a plan view of the track for a siding station for a loading and unloading station, in accordance with one or more embodiments of the present disclosure;

FIG. 11 shows a typical vehicle, in accordance with one or more embodiments of the present disclosure;

FIG. 12 shows a typical vehicle underside view, in accordance with one or more embodiments of the present disclosure;

FIG. 13 shows a typical vehicle with the transfer cams system engaged in the guide channel to transfer the vehicle to a siding, in accordance with one or more embodiments of the present disclosure;

FIG. 14 shows a typical vehicle with the transfer cams system in the siding position, in accordance with one or more embodiments of the present disclosure;

FIG. 15 shows a typical vehicle with the transfer cams system in the main rail position, in accordance with one or more embodiments of the present disclosure;

FIG. 16 shows the transfer cams system in the siding position to transfer the vehicle to a siding, in accordance with one or more embodiments of the present disclosure;

FIG. 17 shows the transfer cams system in the main track position to transfer the along the main track, in accordance with one or more embodiments of the present disclosure;

FIG. 18 shows a typical battery box, in accordance with one or more embodiments of the present disclosure;

FIG. 19 shows a typical battery box cooling system, in accordance with one or more embodiments of the present disclosure;

FIG. 20 shows the overall control system, in accordance with one or more embodiments of the present disclosure;

FIG. 21 shows an alternative power generation configuration for powering the system, in accordance with one or more embodiments of the present disclosure;

FIG. 22, shows a hybrid power track design that is designed to provide power to the vehicle in an intermittent or continuous manner, in accordance with one or more embodiments of the present disclosure;

FIG. 23 shows another detailed view of a hybrid power track design that is designed to provide power to the vehicle in an intermittent or continuous manner, in accordance with one or more embodiments of the present disclosure; and

FIG. 24 shows a second detailed view of a hybrid power track design that is designed to provide power to the vehicle in an intermittent or continuous manner, in accordance with one or more embodiments of the present disclosure.

Corresponding reference characters indicate corresponding parts throughout the several views. The exemplifications set out herein illustrate embodiments of the disclosure and such exemplifications are not to be construed as limiting the scope of the disclosure in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the disclosure.

In the following description, for the purposes of explanation, numerous specific details are set forth in order to provide a thorough understanding of the described embodiments. It will be apparent to one skilled in the art however that other embodiments of the present disclosure may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the disclosure, as other embodiments of the disclosure may omit such features.

In this application the use of the singular includes the plural unless specifically stated otherwise and use of the terms "and" and "or" is equivalent to "and/or," also referred to as “non-exclusive or” unless otherwise indicated. Moreover, the use of the term "including," as well as other forms, such as "includes" and "included," should be considered non-exclusive.

Also, terms such as "element" or "component" encompass both elements and components including one unit and elements and components that include more than one unit, unless specifically stated otherwise.

Lastly, the terms "or" and "and/or" as used herein are to be interpreted as inclusive or meaning any one or any combination. Therefore, "A, B or C" or "A, B and/or C" mean "any of the following: A; B; C; A and B; A and C; B and C; A, B and C." An exception to this definition will occur only when a combination of elements, functions, steps, or acts are in some way inherently mutually exclusive.

As this disclosure is susceptible to embodiments of many different forms, it is intended that the present disclosure be considered as an example of the principles of the disclosure and not intended to limit the disclosure to the specific embodiments shown and described.

The terms vehicle, pod and cart are used interchangeably to mean a vehicle of the instant disclosure.

The term rails and or rail as used in the specification is meant to mean a rail system that is used with the vehicle of the instant disclosure.

The term siding and90-degree vehicle transport device as used in the disclosure mean a siding diversion device for the vehicle of the instant disclosure.

Prior to a discussion of the preferred embodiment of the disclosure, it should be understood that while the features and advantages of the disclosure are illustrated in terms of a track system with individual self contained and self-propelled vehicles.

The personal ecosystem transportation system of the instant disclosure includes a fixed track system with sidings for passenger and freight loading and unloading, a self- contained electrically powered vehicle for passenger or freight transportation, a control system, and a charging system. The vehicle travels on the track system and is equipped with its own electrical power source and control system. The track system is designed to be self-centering to eliminate the use of a track guidance system. The power source for the vehicle is primarily a battery that drives an electric motor, which in turn drives at least one wheel. The system includes two different siding systems to move a vehicle off of the main track.

The personal ecosystem transportation system may include one or more of the following features. The vehicle may be capable of carrying one to four passengers. The vehicle may be equipped with a ride hailing application for passengers to request the vehicle. The control system may be located within the vehicle, allowing the vehicle to operate autonomously. The track system may be self-centering, eliminating the use of a track guidance system. The power source for the vehicle may include an auxiliary fuel cell to provide power to charge the battery. The system may include a 90-degree vehicle transport device as one of the two different siding systems to move a vehicle off of the main track. The system may include a switch siding design as one of the two different siding systems to move a vehicle off of the main track. The control system may comprise a central management system that manages all the vehicles Online analytical processing (OLAP) and online transaction processing (OLTP). The vehicle control system may communicate with the personal ecosystem transportation system control system to schedule recharging and maintenance. The vehicle control system may signal to the personal ecosystem transportation system when the battery of the vehicle requires recharging.

The instant disclosure describes a method of operating a personal ecosystem transportation system includes receiving instructions to pick up either passengers or freight at a specific siding or terminal, transporting those passengers or freight to a specified siding or terminal using a self-contained electrically powered vehicle, controlling the vehicle from within the vehicle to eliminate the use of external control mechanisms for moving the vehicle from the main track to a siding, and scheduling and programming the vehicle control system to proceed to a charging siding once the current assignment is completed when the vehicle control system determines that the battery of the vehicle requires recharging.

The instant disclosure also describes the process by which the personal ecosystem transportation system operates including one or more of the following features. The self- contained electrically powered vehicle may include an auxiliary fuel cell to provide power to charge the battery. The method may include the step of using a ride hailing application to communicate with the personal ecosystem transportation system control system. The ride hailing application may provide real-time tracking of the vehicle's location and estimated arrival times. The vehicle may be moved off of the main track using a 90-degree vehicle transport device, wherein the rails that the vehicle is being transported on moves perpendicular from the main rail and into a portal for loading or unloading. The moveable rail may have a secondary filler track that fits into the main track so other vehicles can proceed without being delayed.

The personal ecosystem transportation system control system can also include a central management system configured to manage all the vehicles Online analytical processing (OLAP) and online transaction processing (OLTP), a portal siding control system, a vehicle control system residing in the vehicle and designed to communicate with the personal ecosystem transportation system control system, and a ride hailing application configured to communicate with the personal ecosystem transportation system control system. The control system provides information to the personal ecosystem transportation system control system to schedule recharging and maintenance.

Alternative embodiments of the personal ecosystem transportation system control system may include one or more of the following features. The vehicle control system may include a motor controller, a battery management system, a user interface, and a communication system to allow the vehicle control system to communicate with the personal ecosystem transportation system control system. The vehicle control system may signal to the personal ecosystem transportation system when the battery requires recharging, and the personal ecosystem transportation system may schedule and program the vehicle control system to proceed to a charging siding once the current assignment is completed.

The personal ecosystem transportation system is built around a one-to-four-person vehicle that travels on rails and has its own electrical power source and control system.

However, the design could be modified to accommodate more passengers. Alternatively, smaller, single-passenger vehicles could be designed for individual use. The vehicle's design could also be modified to accommodate different types of freight, with specialized compartments or attachments for carrying different types of goods. The system receives instructions to pick up either passengers or freight and a specific siding or terminal and transport those passengers or fright to a specified siding or terminal. The passengers can access an request a vehicle using the hailing application that communicates with the personal ecosystem transportation system.

The personal ecosystem transportation system is comprised of a fixed track system with sidings at least one destination for passenger and freight loading and unloading, a self- contained electrically powered passenger or fright transportation module or vehicle, a control system, and a charging system.

The track is fixed and does not have any external control mechanisms for moving the vehicle from the main track to a siding. This allows the vehicles to be controlled from within the vehicle and eliminate the need for following vehicles to possibly be diverted to a siding during the vehicles transit to a destination.

The on-board power supply and control system allows the vehicle to be completely autonomous and eliminates the need to provide power to the track system to power the vehicle. This makes the vehicles autonomous and self-contained minimizing central power distribution systems and centralized control systems.

The track system is self-centering so as to eliminate the need for track guidance system to keep the vehicle on the track. The track system provides the self-centering guidance by providing a transport surface of the track that is angled in towards the centerline of the track and the vehicle wheels are biased so that the angle of the transport surface of the track is similar to the angle of the wheels. However, the track could be designed to be adjustable, allowing for changes in the route or the addition of new destinations. The track could also be designed to have multiple lanes, allowing for more than one vehicle to travel on the track at the same time. This could increase the system's capacity and efficiency.

The power source for the vehicle is primarily a battery that drives an electric motor that in tur drives at least one wheel and preferably two wheels. The power source can also have an auxiliary fuel cell to provide power to charge the battery.

An alternative could be the use of solar panels integrated into the vehicle's design to supplement the battery power or even replace it entirely. This could increase the vehicle's energy efficiency and reduce the frequency of recharging. The vehicle could also be designed to use other forms of renewable energy, such as wind or kinetic energy generated by the vehicle's movement.

A power saving alternative would be to mount solar panels on the support track and integrate it with a battery backup system. Since the track is installed in locations where sunlight exposure is unimpeded this will provide an excellent method of providing power for the system and could also provide power for the grid. The installation of solar panels and the storage systems will reduce the dependence on municipal power for system operation. The solar power capability is significant because a 50-foot section of the triangular panel installation under the track can provide the system with approximately 50 percent power need for one vehicle.

All sections will back-feed to the local utility when no vehicle load is required. The design of triangular truss provides convenient panel mounting under the parallel tracks.

The system provides two different siding systems to move a vehicle off of the main track. The first is a 90-degree vehicle transport device where the rails that the vehicle is being transported on moves perpendicular from the main rail and into a portal for loading or unloading and the moveable rail has a secondary filler track that fits into the main track so other vehicles can proceed without being delayed. Alternatively, the second is a switch siding design. The vehicle has a guide channel to provide lateral force directing the train to the desired direction of the track and the vehicle has at least one and preferably two transfer cam followers that fit in the guide channel. When the vehicle engages the transfer cams the transfer cams will enter the lead in section of the guide channel and the vehicle will be directed to the siding by the transfer cams engaged in the guide channel. The tract main track section provides a transition piece so the vehicle can move on to the siding if the transfer cams are engaged or proceed down the track if the transfer cam is not engaged.

The personal ecosystem transportation system control system comprises of a central management system that manages all the vehicles Online analytical processing (OLAP) and online transaction processing (OLTP), a portal siding control system, a vehicle control system that resides in the vehicle and communicates with the personal ecosystem transportation system control system and a ride hailing application that communicates with the personal ecosystem transportation system control system. The personal ecosystem transportation system control system also interfaces with the users using the ride hailing application and any corporate partners.

The vehicle control system has a motor controller, battery management system, user interface and communication system to allow the vehicle control system to communicate with the personal ecosystem transportation system control system. The control system provides information to the personal ecosystem transportation system control system to schedule recharging and maintenance. The vehicle control system could also be designed to be semi-autonomous, where it can operate independently but also receive instructions from a central control system when necessary.

When the vehicle control system determines that the battery needs recharging it will signal to the personal ecosystem transportation system that the vehicle needs to be recharged and the personal ecosystem transportation system will schedule and program the vehicle control system to proceed to a charging siding once the current assignment is completed.

The personal ecosystem transportation system can additionally be described as a system that may include a fixed track system with sidings for passenger and freight loading and unloading. The track system may be designed to be self-centering, eliminating the use of a track guidance system. This self-centering feature may be achieved by providing a transport surface of the track that is angled in towards the centerline of the track. The vehicle wheels may be biased so that the angle of the transport surface of the track is similar to the angle of the wheels.

The personal ecosystem transportation system may also include a self-contained electrically powered vehicle for passenger or freight transportation. The vehicle may be capable of carrying one to four passengers. The vehicle may travel on the track system and may be equipped with its own electrical power source and control system. The power source for the vehicle may primarily be a battery that drives an electric motor, which in turn drives at least one wheel. In some cases, the power source may also include an auxiliary fuel cell to provide power to charge the battery.

The personal ecosystem transportation system may further include a control system. The control system may be located within the vehicle, allowing the vehicle to operate autonomously. This may eliminate the use of external control mechanisms for moving the vehicle from the main track to a siding and may minimize central power distribution systems and centralized control systems.

The personal ecosystem transportation system may also include a charging system. The vehicle control system may communicate with the personal ecosystem transportation system control system to schedule recharging and maintenance. When the vehicle control system determines that the battery of the vehicle requires recharging, it may signal to the personal ecosystem transportation system. The personal ecosystem transportation system may then schedule and program the vehicle control system to proceed to a charging siding once the current assignment is completed.

The system may include two different siding systems to move a vehicle off of the main track. The first may be a 90-degree vehicle transport device, where the rails that the vehicle is being transported on move perpendicular from the main rail and into a portal for loading or unloading. The moveable rail may have a secondary filler track that fits into the main track so other vehicles can proceed without being delayed. Alternatively, the second may be a switch siding design. The vehicle may have a guide channel to provide lateral force directing the train to the desired direction of the track. The vehicle may have at least one and, in some cases, two transfer cam followers that fit in the guide channel. When the vehicle engages the transfer cams, the transfer cams may enter the lead-in section of the guide channel and the vehicle may be directed to the siding by the transfer cams engaged in the guide channel.

The personal ecosystem transportation system control system may comprise a central management system that manages all the vehicles' Online analytical processing (OLAP) and online transaction processing (OLTP). The control system may also interface with users using a ride hailing application and any corporate partners. The ride hailing application may communicate with the personal ecosystem transportation system control system, allowing passengers to request a vehicle.

One of the main components of the personal ecosystem transportation system is the fixed track system. This track system may be designed to be self-centering, which can eliminate the use of a track guidance system. The self-centering feature of the track system may be achieved by providing a transport surface of the track that is angled in towards the centerline of the track. The vehicle wheels may be biased so that the angle of the transport surface of the track is similar to the angle of the wheels. This design can ensure that the vehicle remains on the track without the use of additional guidance systems.

In some cases, the design of the track system may be adjustable. This could allow for changes in the route or the addition of new destinations. For example, the track system could be modified to include additional sidings or terminals, or to change the direction of the track. This flexibility in the design of the track system could allow the personal ecosystem transportation system to be easily adapted to different transportation requirements.

In other cases, the track system may be designed to have multiple lanes. This could allow for more than one vehicle to travel on the track at the same time. For instance, one lane could be used for passenger vehicles, while another lane could be used for freight vehicles. Alternatively, multiple lanes could be used to increase the capacity of the system, allowing for more vehicles to travel on the track at the same time. This could increase the efficiency of the personal ecosystem transportation system and allow it to handle higher volumes of passengers or freight.

The personal ecosystem transportation system may include a self-contained electrically powered vehicle. This vehicle may be designed to carry one to four passengers, making it suitable for individual or small group transportation. The vehicle's capacity may be adjusted in some cases to accommodate more passengers or different types of freight. For instance, the vehicle design could be modified to include additional seating or specialized compartments for carrying goods. This flexibility in the vehicle design could allow the personal ecosystem transportation system to cater to a wide range of transportation requirements.

The vehicle may be equipped with its own electrical power source, which primarily may be a battery that drives an electric motor. This motor, in turn, may drive at least one wheel of the vehicle, enabling it to move along the track system. In some cases, the power source for the vehicle may also include an auxiliary fuel cell to provide additional power to charge the battery. Alternatively, the vehicle could be equipped with solar panels or other forms of renewable energy as an alternative power source. This could increase the vehicle's energy efficiency and reduce the frequency of recharging, contributing to the sustainability of the personal ecosystem transportation system.

Alternatively, the system may utilize an alternative battery charging concept using segmented powered rails for long duration power.

The charging track sections are non-continuous providing episodic charging to "top off" the battery charge. The powered sections would not be located where the public has access for safety. The segmented power rails provide additional battery capacity by using powered rails for any distance travel. The battery charge controller, or a battery management system charges batteries while in motion and in contact with the – Interrupted power boost. The charge controller, or a battery management system accepts interrupted power and uses the power to charge the battery and or power the vehicle. The battery is used to propel the vehicle in track sections without charging capability. The system can also provide connections that provide the ability for switching actions, power in offsets, communications, and computers etc.

This is unlike the traditional "third rail" approach where all the power is supplied by a continuous powered rail or overhead catenary wire. The vehicle would only be charged when in a position on the track where there is a segmented powered rail, and the vehicle would connect to the rail and the battery charge controller, or a battery management system would charge the battery either during operation or at a siding. The configuration provides unlimited range with continuous duty cycle.

The vehicle may also be equipped with a control system, which may be located within the vehicle itself. This onboard control system may allow the vehicle to operate autonomously, eliminating the use of external control mechanisms for moving the vehicle from the main track to a siding. This autonomous operation could enhance the efficiency of the personal ecosystem transportation system and minimize the use of central power distribution systems and centralized control systems.

Passengers may request the vehicle using a ride hailing application. This application may communicate with the personal ecosystem transportation system control system, allowing passengers to request a vehicle and specify their destination. In some cases, the user interface of the ride hailing application may be designed to be more interactive, providing features such as real-time tracking of the vehicle's location and estimated arrival times. The interface could also be designed to be accessible for users with disabilities, with features such as voice control, large text, and high-contrast colors. This could make the personal ecosystem transportation system more user-friendly and accessible to a wider range of users.

The power source for the vehicle in the personal ecosystem transportation system is primarily a battery. This battery may drive an electric motor, which in turn drives at least one wheel of the vehicle. This arrangement allows the vehicle to move along the track system. In some cases, the power source for the vehicle may also include an auxiliary fuel cell. This auxiliary fuel cell may provide additional power to charge the battery, enhancing the vehicle's operational efficiency and reducing the frequency of recharging. The integration of an auxiliary fuel cell into the vehicle's power source may provide a reliable and efficient power supply, ensuring the vehicle's continuous operation even during long journeys or periods of high demand.

In some variations of the personal ecosystem transportation system, the vehicle may be equipped with a remote-control system. This remote-control system may allow the vehicle to be controlled from a central location, which could facilitate more efficient management of multiple vehicles, especially in a large transportation network. This could enhance the overall efficiency and reliability of the personal ecosystem transportation system, as it allows for centralized control and coordination of all vehicles in the system.

In other variations, the vehicle may be equipped with a semi-autonomous control system. This semi-autonomous control system may allow the vehicle to operate independently for the majority of the time, but also receive instructions from a central control system when deemed appropriate or when specific conditions are met. This could provide a balance between autonomous operation, which can enhance efficiency and reduce the reliance on centralized control systems, and centralized control, which can provide oversight and coordination when it is beneficial or when unexpected situations arise.

The personal ecosystem transportation system may include two different siding systems to move a vehicle off of the main track. One of these siding systems may be a 90- degree vehicle transport device. In this configuration, the rails that the vehicle is being transported on may move perpendicular from the main rail and into a portal for loading or unloading. This design allows the vehicle to be moved off the main track without disrupting the flow of other vehicles on the track. To facilitate this, the moveable rail may have a secondary filler track that fits into the main track. This allows other vehicles to proceed without being delayed, enhancing the overall efficiency of the personal ecosystem transportation system.

Alternatively, the personal ecosystem transportation system may include a switch siding design as one of the two different siding systems to move a vehicle off of the main track. In this configuration, the vehicle may have a guide channel to provide lateral force directing the vehicle to the desired direction of the track. The vehicle may have at least one and, in some cases, two transfer cam followers that fit in the guide channel. When the vehicle engages the transfer cams, the transfer cams may enter the lead-in section of the guide channel and the vehicle may be directed to the siding by the transfer cams engaged in the guide channel. This design allows the vehicle to be moved off the main track in a controlled and efficient manner, enhancing the overall operation of the personal ecosystem transportation system.

The personal ecosystem transportation system may include a control system. This control system may be located within the vehicle, allowing the vehicle to operate autonomously. This autonomous operation may eliminate the use of external control mechanisms for moving the vehicle from the main track to a siding and may minimize central power distribution systems and centralized control systems. The control system may comprise a central management system that manages all the vehicles' Online analytical processing (OLAP) and online transaction processing (OLTP). This central management system may facilitate efficient management and coordination of all vehicles in the system, enhancing the overall operation of the personal ecosystem transportation system.

In some variations of the personal ecosystem transportation system, the control system may include a portal siding control system, a vehicle control system residing in the vehicle, and a ride hailing application. The vehicle control system may be designed to communicate with the personal ecosystem transportation system control system, allowing for efficient communication and coordination between the vehicle and the overall system. The ride hailing application may be configured to communicate with the personal ecosystem transportation system control system, providing a user-friendly interface for passengers to request a vehicle and specify their destination.

The vehicle control system may include a motor controller, a battery management system, a user interface, and a communication system. The motor controller may control the operation of the electric motor that drives the vehicle, while the battery management system may monitor and manage the battery's performance and charging status. The user interface may provide a means for passengers to interact with the vehicle control system, while the communication system may allow the vehicle control system to communicate with the personal ecosystem transportation system control system. This communication may facilitate the scheduling of recharging and maintenance for the vehicle, enhancing the overall efficiency and reliability of the personal ecosystem transportation system.

The vehicle control system is a central component of the personal ecosystem transportation system. This system may reside within the vehicle itself, enabling the vehicle to operate autonomously. The vehicle control system may include several components, such as a motor controller, a battery management system, a user interface, and a communication system. The motor controller may control the operation of the electric motor that drives the vehicle, while the battery management system may monitor and manage the battery's performance and charging status. The user interface may provide a means for passengers to interact with the vehicle control system, while the communication system may allow the vehicle control system to communicate with the personal ecosystem transportation system control system.

In some cases, the vehicle control system may communicate with the personal ecosystem transportation system control system to schedule recharging and maintenance. This communication may be facilitated by the communication system of the vehicle control system. When the vehicle control system determines that the battery of the vehicle requires recharging, it may signal to the personal ecosystem transportation system. The personal ecosystem transportation system may then schedule and program the vehicle control system to proceed to a charging siding once the current assignment is completed. This efficient communication and coordination between the vehicle control system and the personal ecosystem transportation system control system may enhance the overall operation of the personal ecosystem transportation system.

In addition to the vehicle control system, passengers may interact with the personal ecosystem transportation system through a ride hailing application. This application may communicate with the personal ecosystem transportation system control system, allowing passengers to request a vehicle and specify their destination. In some cases, the ride hailing application may provide real-time tracking of the vehicle's location and estimated arrival times. This feature may enhance the user experience by providing passengers with up-to-date information about their ride.

In the personal ecosystem transportation system, the scheduling and programming of recharging and maintenance for the vehicle may be an integral part of the system's operation. This process may be facilitated by the communication between the vehicle control system and the personal ecosystem transportation system control system. The vehicle control system, which may reside within the vehicle itself, may monitor the status of the vehicle's battery and other components. When the vehicle control system determines that the battery requires recharging or that maintenance is due, it may signal to the personal ecosystem transportation system control system.

In response to this signal, the personal ecosystem transportation system control system may schedule and program the vehicle control system to proceed to a charging siding once the current assignment is completed. This may involve directing the vehicle to a specific siding equipped with charging facilities. The vehicle may then be recharged while it is not in use, ensuring that it is ready for its next assignment. This efficient scheduling and programming of recharging and maintenance may enhance the overall operation of the personal ecosystem transportation system, ensuring that the vehicles are consistently in good working order and ready for use.

In some cases, the scheduling and programming of recharging and maintenance may be automated, with the personal ecosystem transportation system control system automatically scheduling these tasks based on the signals received from the vehicle control system. This may further enhance the efficiency of the personal ecosystem transportation system, reducing the manual intervention and oversight that may otherwise be involved in managing the recharging and maintenance of the vehicles.

In other cases, the scheduling and programming of recharging and maintenance may be managed by a central management system that is part of the personal ecosystem transportation system control system. This central management system may manage all the vehicles' Online analytical processing (OLAP) and online transaction processing (OLTP), facilitating efficient management and coordination of all vehicles in the system. This may include scheduling and programming of recharging and maintenance for each vehicle based on the signals received from the vehicle control system.

The above and other objects, which will be apparent to those skilled in the art, are achieved in the present disclosure which is directed to creating a personal transportation system that utilizes fix track to move people and freight from point to point efficiently and safely.

Further disclosure of the instant disclosure can further disclose the switching mechanism of the vehicle. As with all current wheeled transportation systems the instant disclosure travels on a ground or elevated track including one or more person or cargo carrying vehicles. The direction of the vehicle on the multi-directional track requires a method to mechanically direct it from one to another track. This is traditionally implemented with an externally controlled switch using a pair of two position switch rails externally controlled without input from the vehicle.

The multi-directional track requires that the vehicle be a slave to external control. An external force moves the pair of switch rails such that the vehicle wheels will follow the rails to in either a straight or proceed to a turn off for the vehicle.

The switching device of the instant disclosure works differently and permits control from inside the vehicle. The control is enabled using switchable guide pins which engage a slot or channel in the supporting track which directs the vehicle to turn to an adjacent track or remain on the current track. These pins are controlled from the vehicle to select the desired track.

A pair of two position roller guides attached to the front and rear of the vehicle engage the channel to provide lateral force directing the vehicle to the desired direction of the track.

As the vehicle approach a siding the pair of two position roller guides can be activated to engage the siding guide slot or the straight guide slot. If the siding guide slot is selected by the vehicle controller the pair of two position roller guides attached to the front and rear of the vehicle engage the siding guide slot or channel to provide lateral force directing the vehicle to the desired direction of the track. The vehicle then proceeds down the track to the siding position. If the vehicle is not programed to use the siding, then the vehicle proceeds along the main track. The rails at the switch section of the track for the siding are flat and do not have the vertical support sections so the vehicle wheels can traverse the switch or go along the main track. The two position roller guides either engage in the siding guide slot or channel to ensure that the vehicle takes the correct track.

A personal ecosystem transportation system, comprising:
a. a fixed track system with sidings for passenger and freight loading and unloading;
b. a self-contained electrically powered vehicle for passenger or freight transportation;
c. a control system;
d. and a charging system;
e. wherein the vehicle travels on the track system and is equipped with its own electrical power source and control system;
f. wherein the track system is designed to be self-centering to eliminate the use of a track guidance system;
g. wherein the power source for the vehicle is primarily a battery that drives at least one electric motor, which in turn drives at least one wheel; and
h. wherein the system includes a siding system and a 90-degree vehicle transport device to move a vehicle off of the main track.

The personal ecosystem transportation system of the instant disclosure, wherein the siding system is comprised of at least one transfer cams attached to the vehicle, at least one guide channel attached to the main track channel a siding guide channel and the transfer cam engages in the siding guide channel and the track has a flat transfer track local to the siding guide channel and the flat transfer track wheels of the vehicle to roll to move the vehicle to the siding to allow the vehicle to move to the loading station.

The personal ecosystem transportation system of the instant disclosure, wherein the vehicle is equipped with a ride hailing application for passengers to request the vehicle.

The personal ecosystem transportation system of the instant disclosure, wherein the vehicle control system is located within the vehicle, allowing the vehicle to operate autonomously.

The personal ecosystem transportation system of the instant disclosure, wherein the power source for the vehicle includes an auxiliary fuel cell to provide power to charge the battery.

The personal ecosystem transportation system of the instant disclosure, wherein the 90-degree vehicle transport device is configured to move a vehicle off of the main track.

The personal ecosystem transportation system of the instant disclosure, wherein the system includes a switch siding design as one of the two different siding systems to move a vehicle off of the main track.

The personal ecosystem transportation system of the instant disclosure, wherein the control system comprises a central management system that manages all the vehicles Online analytical processing (OLAP) and online transaction processing (OLTP).

The personal ecosystem transportation system of the instant disclosure, wherein the vehicle control system communicates with the personal ecosystem transportation system control system to schedule recharging and maintenance.

The personal ecosystem transportation system of the instant disclosure, wherein the vehicle control system signals to the personal ecosystem transportation system when the battery of the vehicle requires recharging.

A method of operating a personal ecosystem transportation system, the method comprising:
a. receiving instructions to pick up either passengers or freight at a specific siding or terminal;
b. transporting those passengers or freight to a specified siding or terminal using a self- contained electrically powered vehicle;
c. controlling the vehicle from within the vehicle to eliminate the use of external control mechanisms for moving the vehicle from the main track to a siding;
d. scheduling and programming the vehicle control system to proceed to a charging siding once the current assignment is completed when the vehicle control system determines that the battery of the vehicle requires recharging.

The method of the instant disclosure, wherein the self-contained electrically powered vehicle includes an auxiliary fuel cell to provide power to charge the battery.

The method of the instant disclosure, further comprising the step of using a ride hailing application to communicate with the personal ecosystem transportation system control system.

The method of the instant disclosure, wherein the ride hailing application provides real-time tracking of the vehicle's location and estimated arrival times.

The method of the instant disclosure, wherein the vehicle is moved off of the main track using a 90-degree vehicle transport device, wherein the rails that the vehicle is being transported on moves perpendicular from the main rail and into a portal for loading or unloading.

The method of the instant disclosure, wherein the moveable rail has a secondary filler track that fits into the main track so other vehicles can proceed without being delayed.

A personal ecosystem transportation system control system, comprising:
a. a central management system configured to manage all the vehicles Online analytical processing (OLAP) and online transaction processing (OLTP);
b. a portal siding control system;
c. a vehicle control system residing in the vehicle and designed to communicate with the personal ecosystem transportation system control system;
d. and a ride hailing application configured to communicate with the personal ecosystem transportation system control system;
e. wherein the control system provides information to the personal ecosystem transportation system control system to schedule recharging and maintenance.

The personal ecosystem transportation system control system of the instant disclosure, wherein the vehicle control system includes a motor controller, a battery management system, a user interface, and a communication system to allow the vehicle control system to communicate with the personal ecosystem transportation system control system.

The personal ecosystem transportation system control system of the instant disclosure, wherein the vehicle control system signals to the personal ecosystem transportation system when the battery requires recharging, and the personal ecosystem transportation system schedules and programs the vehicle control system to proceed to a charging siding once the current assignment is completed.

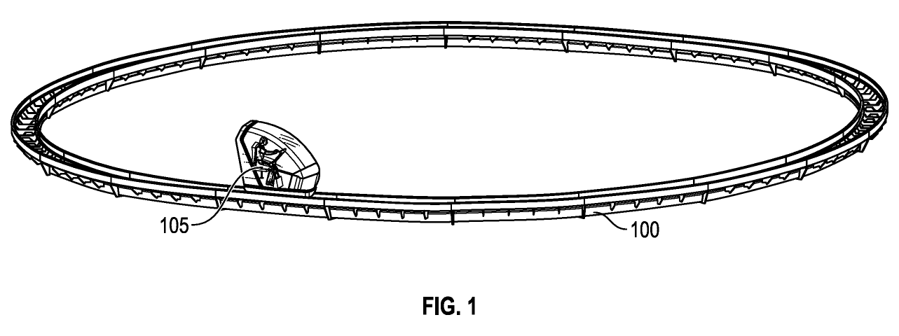

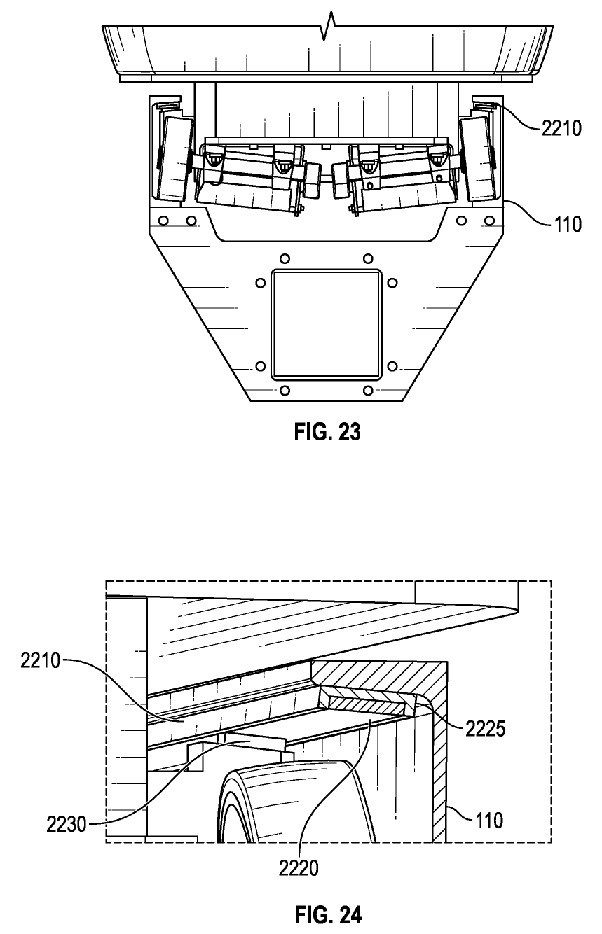

Referring now to the drawings FIGS. 1-24, and more particularly to FIG. 1, there is shown a typical personal ecosystem transportation system 100 and vehicle 105, according to aspects of the present disclosure.

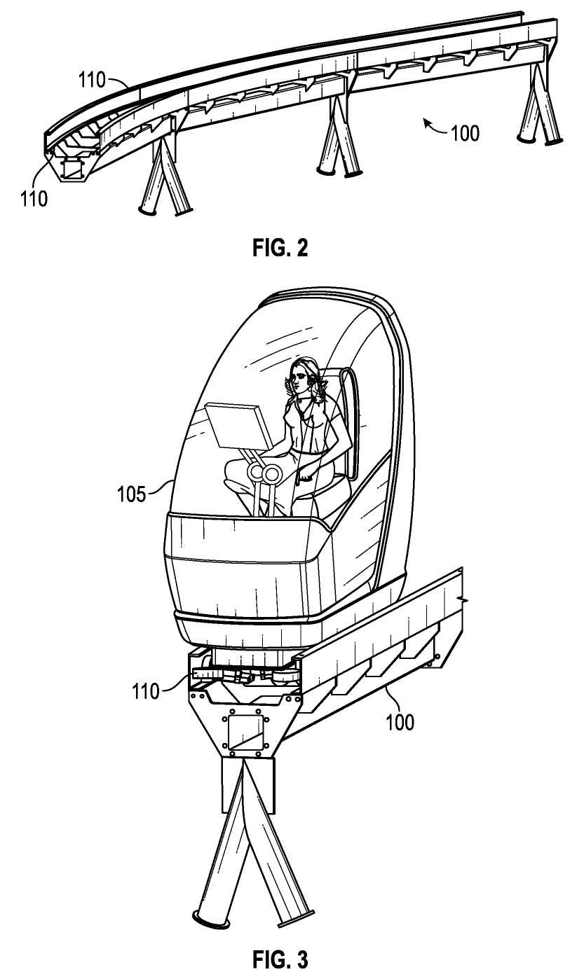

FIG. 2 is a typical view of the track system of the instant disclosure showing typical personal ecosystem transportation system 100 and track 110.

FIG. 3 is a typical view of the vehicle and track system of the instant disclosure showing typical personal ecosystem transportation system 100, vehicle 105 and track 110.

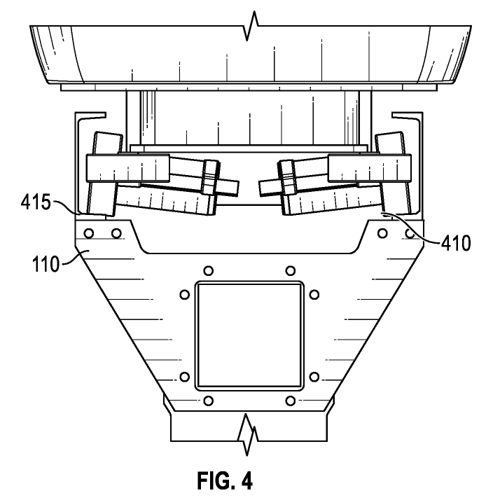

FIG. 4 typical view of the vehicle and track system showing the wheels 410, track 110 and rails 415 of the instant disclosure.

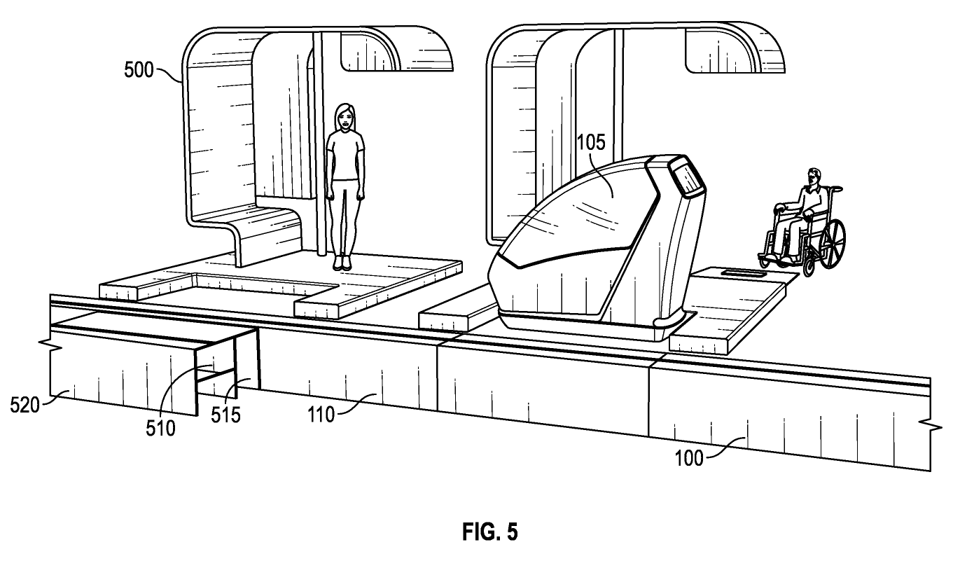

FIG. 5 typical view of the vehicle loading station 500 for passengers of the instant disclosure. The drawing shows vehicle 105, personal ecosystem transportation system 100, track 110, horizontal transfer system 520 comprised of transfer track 515 and filler track 510.

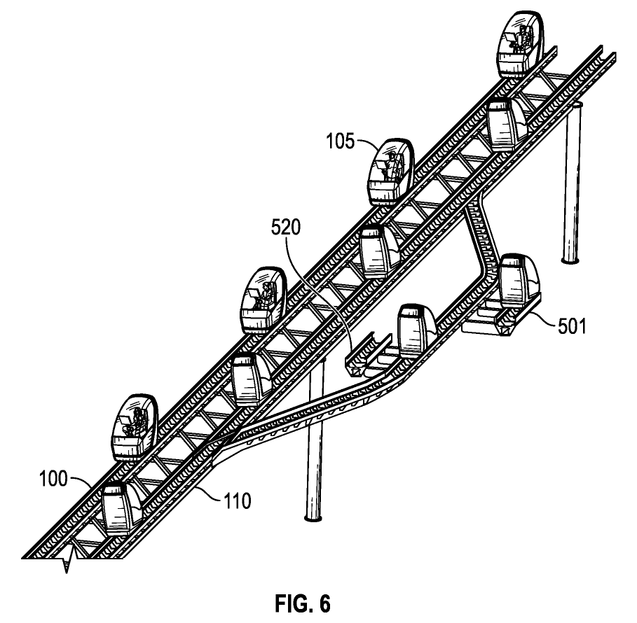

FIG. 6 typical view of the vehicle siding system for a loading station for passengers or freight of the instant disclosure showing the siding vehicle loading station 501 for passengers of the instant disclosure, vehicle 105, personal ecosystem transportation system 100, track 110, transfer system 520.

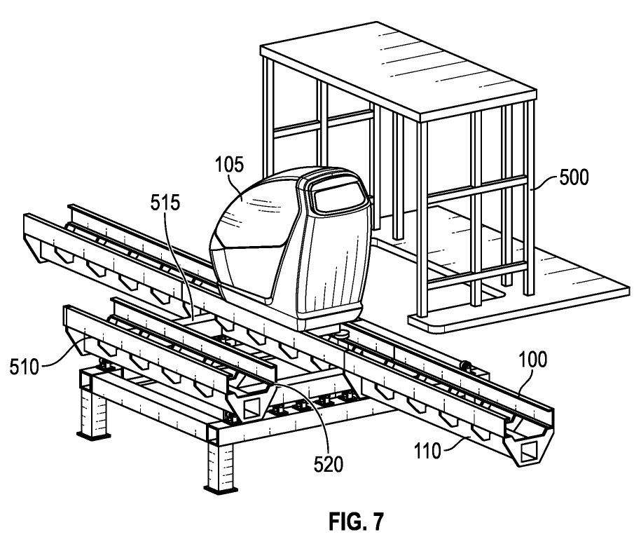

FIG. 7 shows the vehicle transfer station with a vehicle proceeding on the main track of the instant disclosure showing vehicle loading station 500 for passengers of the instant disclosure, vehicle 105, personal ecosystem transportation system 100, track 110, transfer system 520, transfer track 515 and filler track 510.

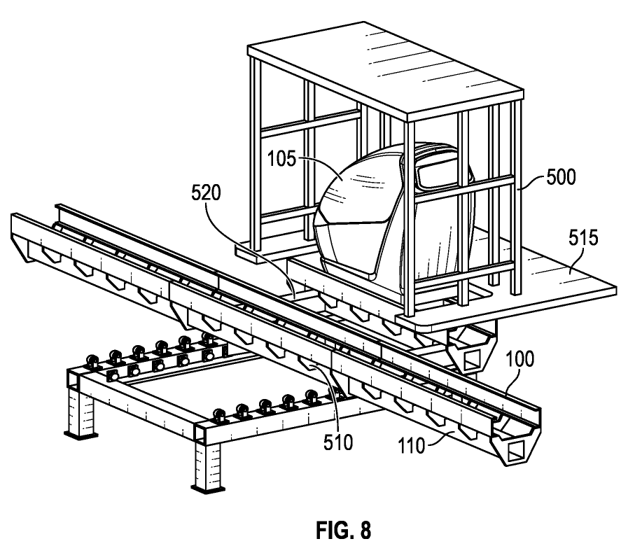

FIG. 8 shows the vehicle transfer station with a vehicle moved to the loading and unloading station of the instant disclosure showing vehicle loading station 500 for passengers of the instant disclosure, vehicle 105, personal ecosystem transportation system 100, track 110, transfer system 520, transfer track 515 and filler track 510.

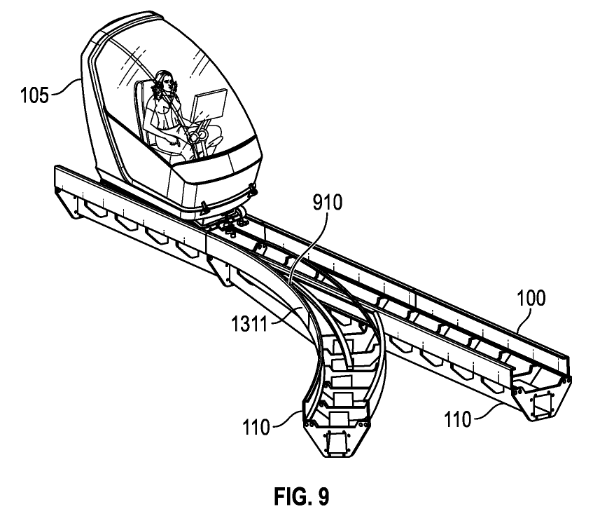

FIG. 9 shows the vehicle and siding vehicle loading station 501 with a vehicle moving to the loading and unloading station of the instant disclosure showing vehicle 105, personal ecosystem transportation system 100, track 110 and guide channel 910 and siding guide channel 1311.

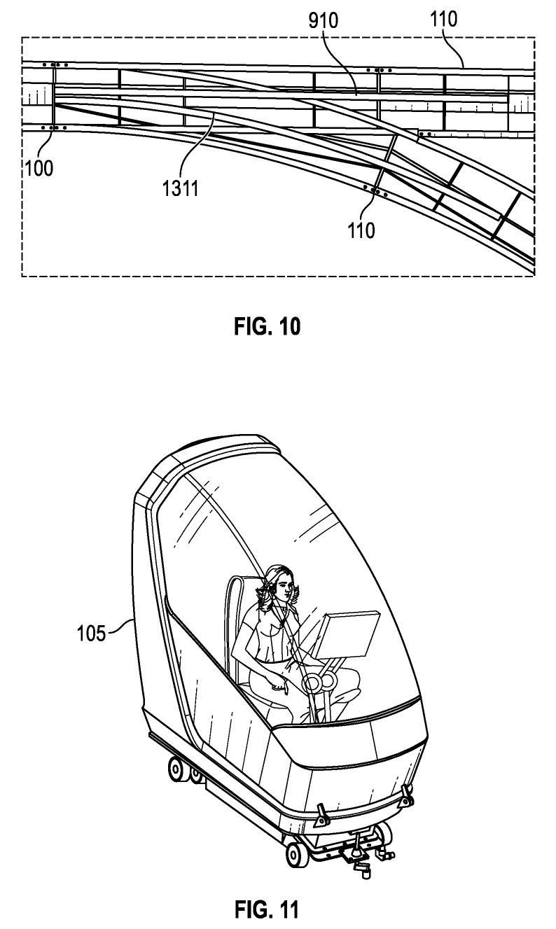

FIG. 10 shows a plan view of the track for a siding station for a loading and unloading station of the instant disclosure. The view shows personal ecosystem transportation system 100, track 110 and guide channel 910 and siding guide channel 1311.

FIG. 11 shows a typical vehicle 105 of the instant disclosure.

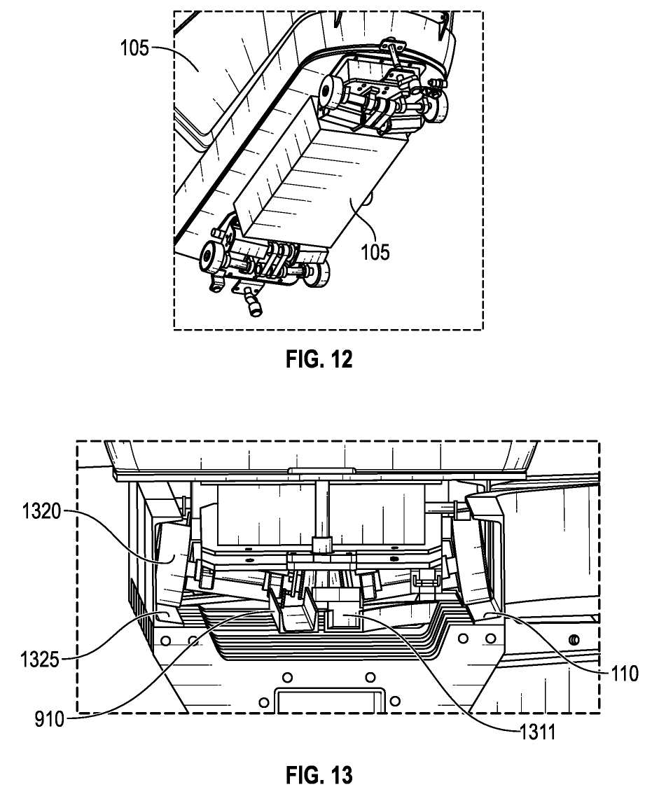

FIG. 12 shows a typical vehicle 105 underside 1210 of the instant disclosure.

FIG. 13 shows a typical vehicle with the transfer cams 1310 engaged in the guide channel 1311 to transfer the vehicle 105 to a siding of the instant disclosure. The vehicle 105 shown in FIG. 10 has wheels 1320 ride that in track 110. The wheels 1320 are installed on vehicle 105 shown in FIG. 10 so they match the angle of the flange 1325 of track 110.

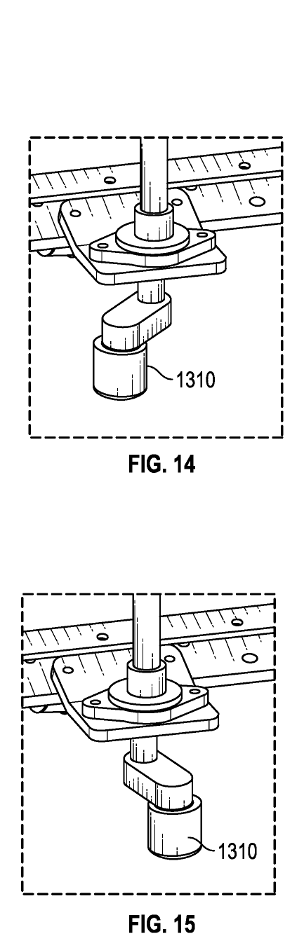

FIG. 14 shows a typical vehicle with the transfer cams 1310 of the instant disclosure in the siding position.

FIG. 15 shows a typical vehicle with the transfer cams 1310 of the instant disclosure in the main rail position.

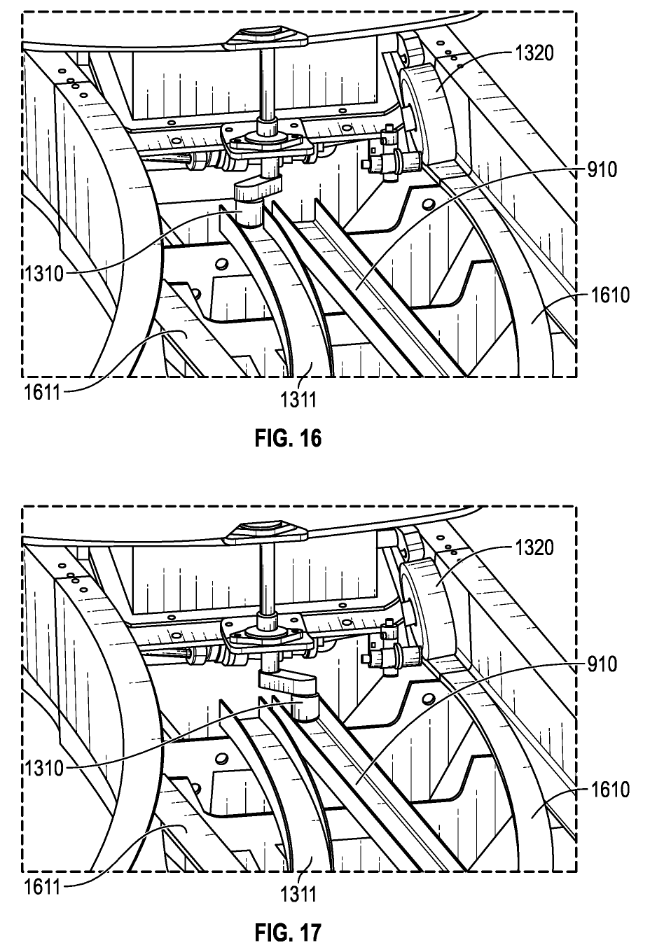

FIG. 16 shows the transfer cams 1310 of the instant disclosure in the siding position to transfer the vehicle to a siding. The guide channel 910 is the main track guide channel and the siding guide channel 1311 is shown with transfer cam 1310 engaged in siding guide channel 1311. The flat transfer track 1610 and flat transfer track 1611 allow the wheels 1320 to roll to move the vehicle 105 shown in FIG. 10 to the siding vehicle loading station 501 shown in FIG. 6.

FIG. 17 shows the transfer cams 1310 of the instant disclosure in the main track position to transfer the vehicle 105 shown in FIG. 10 the along the track 110. The guide channel 910 is the main track guide channel and the siding guide channel 1311 is shown with transfer cam 1310 engaged in guide channel 910. The flat transfer track 1610 and flat transfer track 1611 allow the wheels 1320 to roll to move the vehicle 105 shown in FIG. 10 to the siding vehicle loading station 501 shown in FIG. 6.

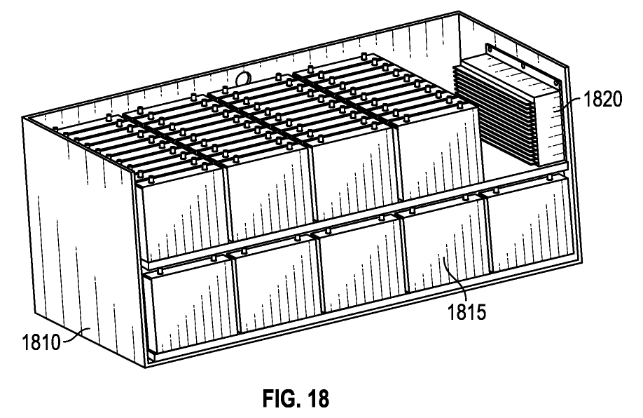

FIG. 18 shows a typical battery box 1810 of the instant disclosure showing cells 1815 and battery management system 1820.

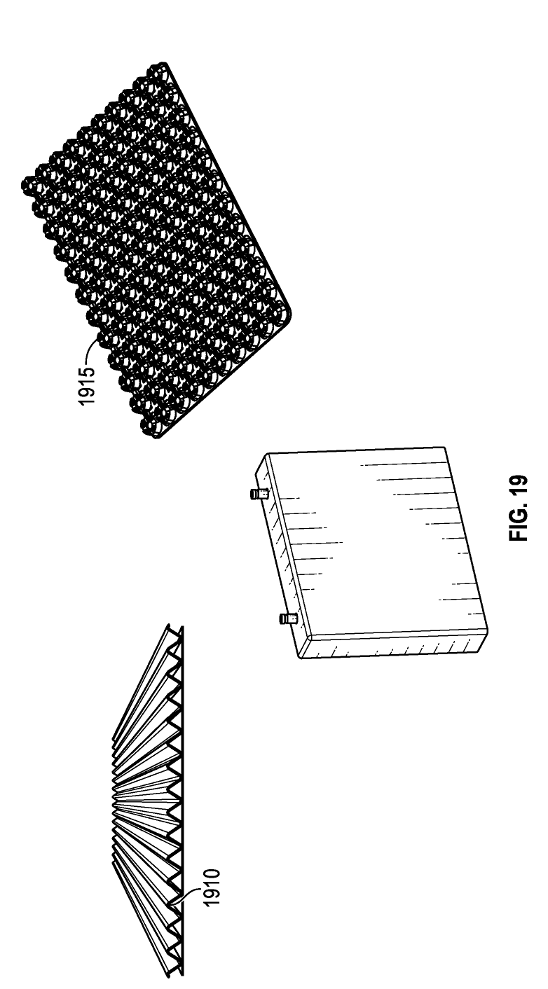

FIG. 19 shows a typical battery box cooling system of the instant disclosure showing corrugated plastic wrap 1910 and hollow plastic spacers 1915 to provide air flow for cell cooling.

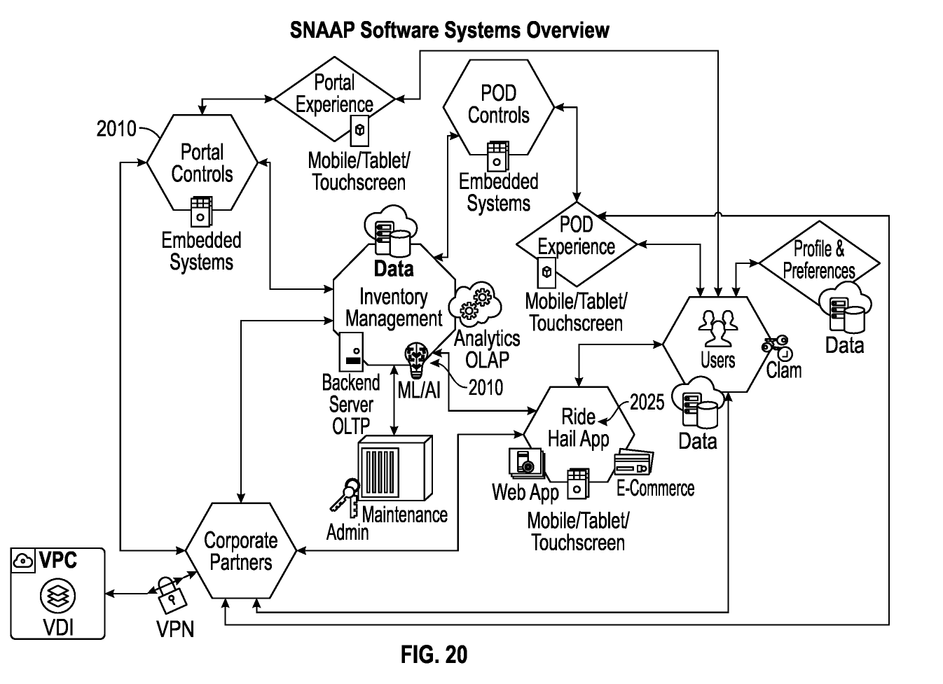

FIG. 20 shows the overall control system for the instant disclosure. The inventory control system 2010 that has both the Online analytical processing (OLAP) 2015 and online transaction processing (OLTP) 2020 modules, the ride share application 2025, vehicle or pod control system 2030, the siding or vehicle loading station 500 and siding vehicle loading station 501 controls 2035.

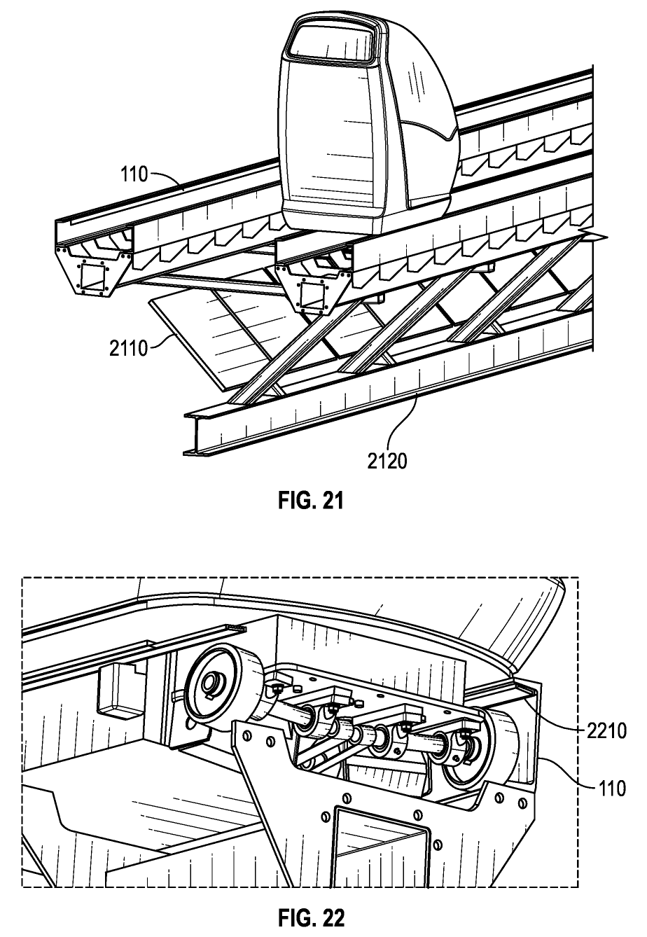

FIG. 21 shows a alternative power generation configuration for powering the system. The solar panels can be placed above or below the track. FIG. 21 shows a solar panel 2110 located under the track 110 and attached to the support truss 2120.

FIGS. 22, 23, and 24, show a hybrid power track design that is designed to provide power to the vehicle in an intermittent or continuous manner. The vehicle can connect to a power rail 2210 at a siding when stationary for continuous charging or the vehicle can connect to a power rail while moving on the track 110. The design provides electric power from the tracks to the vehicle and utilizes a nearly continuous charging copper strip 2220 inside track 110 to provide the power. The copper strip 2220 is insulated by sleeve 2225 so that power cannot be transferred to the track 110. A brush 2230 contacts the charging copper strip 2220, and the power is transferred to the vehicle 105 shown in FIG. 1 by means of the brush 2230.

The design provides episodic charging of the battery 1810 shown in FIG. 18 when the vehicle 105 passes a powered section of rail or is parked at a siding vehicle loading station 500 shown in FIG. 7 or on the power section of rail 2210. The system would not be installed where it could pose a safety risk.

Brush 2230 contacting continuous charging copper strip 2220 connected to battery charger and battery management system and uses the power to charge the vehicle battery 1810 shown in FIG. 18. This system provides optimum battery charging to promote battery optimum battery life and is designed so that voltages will keep the battery approximately half charge thereby providing a reserve.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine- readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above- described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the disclosure, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the disclosure should be determined by the appended claims and their legal equivalents.

In addition, the present disclosure has been described with reference to embodiments, it should be noted and understood that various modifications and variations can be crafted by those skilled in the art without departing from the scope and spirit of the disclosure. Accordingly, the foregoing disclosure should be interpreted as illustrative only and is not to be interpreted in a limiting sense. Further it is intended that any other embodiments of the present disclosure that result from any changes in application or method of use or operation, method of manufacture, shape, size, or materials which are not specified within the detailed written description or illustrations contained herein are considered within the scope of the present disclosure.

Insofar as the description above and the accompanying drawings disclose any additional subject matter that is not within the scope of the claims below, the disclosure is not dedicated to the public and the right to file one or more applications to claim such additional inventions is reserved.

Although very narrow claims are presented herein, it should be recognized that the scope of this disclosure is much broader than presented by the claim. It is intended that broader claims will be submitted in an application that claims the benefit of priority from this application.

While this disclosure has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A personal ecosystem transportation system, comprising:
a fixed track system comprising one or more sidings for passenger and freight loading and unloading;
a self-contained electrically powered vehicle for passenger or freight transportation;
a vehicle control system; and
a charging system;
wherein the self-contained electrically powered vehicle travels on the fixed track system and is operably connected to an electrical power source and the vehicle control system;
wherein the fixed track system is designed to be self-centering to eliminate the use of a track guidance system;
wherein the electrical power source for the self-contained electrically powered vehicle is primarily a battery that drives at least one electric motor, which in turn drives at least one wheel; and
wherein the fixed track system includes a siding system and a horizontal transfer system to move the self-contained electrically powered vehicle off of a main track channel.

2. The personal ecosystem transportation system of claim 1, wherein the siding system comprises:
at least one transfer cam attached to the self-contained electrically powered vehicle;
at least one guide channel attached to the main track channel; and
a siding guide channel,
wherein said at least one transfer cam engages in said siding guide channel,
wherein the fixed track system comprises a flat transfer track local to said siding guide channel, the flat transfer track allows the at least one wheel to roll to move said self-contained electrically powered vehicle to one or more sidings to allow said self-contained electrically powered vehicle to move to a loading station.

3. The personal ecosystem transportation system of claim 1, wherein the self-contained electrically powered vehicle is equipped with a ride hailing application for passengers to request the self-contained electrically powered vehicle.

4. The personal ecosystem transportation system of claim 1, wherein the vehicle control system is located within the self-contained electrically powered vehicle, allowing the self-contained electrically powered vehicle to operate autonomously.

5. The personal ecosystem transportation system of claim 1, wherein the power source for the self-contained electrically powered vehicle includes an auxiliary fuel cell to provide power to charge the battery.

6. The personal ecosystem transportation system of claim 1, wherein the system includes a 90-degree vehicle transport device configured to move the self-contained electrically powered vehicle off of the main track channel.

7. The personal ecosystem transportation system of claim 1, wherein the system includes a switch siding design configured to move the self-contained electrically powered vehicle off of the main track channel.

8. The personal ecosystem transportation system of claim 1, wherein the vehicle control system comprises a central management system that manages the self-contained electrically powered vehicle’s Online analytical processing (OLAP) and online transaction processing (OLTP).

9. The personal ecosystem transportation system of claim 1, wherein the vehicle control system communicates with a personal ecosystem transportation system control system to schedule recharging and maintenance.

10. The personal ecosystem transportation system of claim 1, wherein the vehicle control system signals to the personal ecosystem transportation system when the battery of the self-contained electrically powered vehicle requires recharging.

11. A method of operating a personal ecosystem transportation system, the method comprising:
receiving instructions to pick up either passengers or freight at a specified siding or terminal;
transporting the passengers or freight to the specified siding or terminal using a self-contained electrically powered vehicle;
controlling the self-contained electrically powered vehicle from within the self-contained electrically powered vehicle to move the self-contained electrically powered vehicle from a main track to a siding; and
scheduling and programming a vehicle control system to proceed to a charging siding when the vehicle control system determines that a battery of the vehicle requires recharging.

12. The method of claim 11, wherein the self-contained electrically powered vehicle includes an auxiliary fuel cell to provide power to charge the battery.

13. The method of claim 11, further comprising the step of using a ride hailing application to communicate with a personal ecosystem transportation system control system.

14. The method of claim 11, wherein the ride hailing application provides real-time tracking of a location of the self-contained electrically powered vehicle and estimated arrival times.

15. The method of claim 11, wherein the vehicle is moved off of the main track using a 90-degree vehicle transport device, wherein a moveable rail that the self-contained electrically powered vehicle is being transported on moves perpendicular from the main track and into a portal for loading or unloading.

16. The method of claim 15, wherein the moveable rail has a secondary filler track that fits into the main track so other vehicles can proceed without being delayed.

17. The method of claim 11, wherein proceeding to a charging siding is scheduled after a current assignment is completed.

18. A personal ecosystem transportation system control system, comprising:
a central management system configured to manage an Online analytical processing (OLAP) and an online transaction processing (OLTP) of a vehicle;
a portal siding control system;
a vehicle control system residing in the vehicle and designed to communicate with the personal ecosystem transportation system control system; and
a ride hailing application configured to communicate with the personal ecosystem transportation system control system;
wherein the vehicle control system provides information to the personal ecosystem transportation system control system to schedule recharging and maintenance.

19. The personal ecosystem transportation system control system of claim 18, wherein the vehicle control system includes a motor controller, a battery management system, a user interface, and a communication system to allow the vehicle control system to communicate with the personal ecosystem transportation system control system.

20. The personal ecosystem transportation system control system of claim 19, wherein the vehicle control system signals to the personal ecosystem transportation system control system when the battery requires recharging, and the personal ecosystem transportation system control system schedules and programs the vehicle control system to proceed to a charging siding once a current assignment is completed.
